(19) United States
(12) Patent Application Publication
(10) Pub. No.: US 2022/0070431 A1
(43) Pub. Date: Mar. 3, 2022

(54) ELECTRONIC DEVICE AND METHOD FOR IDENTIFYING RELEVANT DEVICE IN AUGMENTED REALITY MODE OF ELECTRONIC DEVICE

(71) Applicant: Samsung Electronics Co., Ltd., Suwon-si (KR)

(72) Inventors: Dmytro SYDORENKO, Kyiv (UA); Svitlana ALKHIMOVA, Kyiv (UA); Volodymyr SAVIN, Kyiv (UA); Artem SHCHERBINA, Kyiv (UA); Gibyoung KIM, Suwon-si (KR); Ivan BONDARETS, Kyiv (UA)

(21) Appl. No.: 17/116,298

(22) Filed: Dec. 9, 2020

(30) Foreign Application Priority Data
Aug. 25, 2020 (KR) 10-2020-0106773

(51) Int. Cl. H04N 13/194; G02B 27/01; G06T 19/00

(52) U.S. Cl. CPC H04N 13/194; G02B 27/0101; G02B 2027/0123; G02B 27/0172; G02B 2027/0178; G06T 19/006

(57) ABSTRACT

An electronic device for identifying an external electronic device and a method therefor are provided. The electronic device includes a camera, a display, and a processor configured to, in case communication with a first external electronic device is established while providing augmented reality via the display, identify the first external electronic device among at least one external electronic device present in a field of view of the camera based on information received from the first external electronic device and information obtained from the camera and display information related to the first external electronic device in the augmented reality (AR) provided via the display, as virtual object information.

### CROSS-REFERENCE TO RELATED APPLICATION(S)

This application is based on and claims priority under 35 U.S.C. § 119 of a Korean patent application number 10-2020-0106773, filed on Aug. 25, 2020, in the Korean Intellectual Property Office, the disclosure of which is incorporated by reference herein in its entirety.

### BACKGROUND

### 1. Field

The disclosure relates to an electronic device capable of identifying an external electronic device related to the electronic device among at least one external electronic device displayed in augmented reality (AR) provided from the electronic device and a method for identifying a relevant external electronic device in an augmented reality mode of the electronic device.

### 2. Description of the Related Art

Augmented reality (AR) is part of virtual reality and refers to technology that allows a virtual object to look present in the original environment by synthesizing the virtual object or information with the actual environment. In other words, a virtual image is projected onto the actual image the user is viewing and displayed to the user. Through augmented reality technology, users may feel a direct sense of reality experienced in the objective physical world and may have experiences that cannot in the real world. Augmented reality is distinguished from virtual reality in which the actual ambient environment cannot be seen and is meaningful in providing a better sense of reality and additional information through a mixture of the real environment and virtual objects.

As augmented reality technology is currently included in various types of electronic devices, users may easily receive a service according to the augmented reality technology through the electronic device.

The electronic device may provide augmented reality (AR) through a display and, in the augmented reality, information related to each of at least one external electronic device may be overlaid and displayed on virtual object information while displaying the at least one external electronic device present in the field of view of the camera of the electronic device.

However, upon displaying all of the information related to each of the at least one external electronic device, as virtual object information, while displaying the at least one external electronic device present in the field of view of the camera of the electronic device in the augmented reality provided via the display of the electronic device, the user of the electronic device may have difficulty in identifying a specific external electronic device related to the electronic device. For example, when communication is established between the electronic device and a specific external electronic device among the at least one external electronic device, if the information related to each of the at least one external electronic device while displaying the at least one external electronic device in the augmented reality, the user may have difficulty in identifying the specific external electronic device establishing communication with the electronic device.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device capable of identifying an external electronic device related to the electronic device among at least one external electronic device displayed in augmented reality (AR) provided from the electronic device and a method for identifying a relevant external electronic device in an augmented reality mode of the electronic device.

Additional aspects will be set forth in part in the description which follows and, in part, will be apparent from the description, or may be learned by practice of the presented embodiments.

In accordance with an aspect of the disclosure, an electronic device is provided. The electronic device includes a camera, a display, a transceiver and a processor configured to, in case communication with a first external electronic device is established via the transceiver while providing augmented reality via the display, identify the first external electronic device among one or more external electronic devices present in a field of view of the camera based on information received from the first external electronic device and information obtained from the camera, and display information related to the first external electronic device in the augmented reality (AR) provided via the display, as virtual object information.

In accordance with another aspect of the disclosure, a method for identifying a relevant device in an augmented reality mode of an electronic device is provided. The method includes establishing communication with a first external electronic device while providing augmented reality via a display of the electronic device, identifying the first electronic device among one or more external devices present in a field of view of a camera of the electronic device based on information obtained from the camera of the electronic device and information received from the first electronic device, and displaying information related to the first electronic device in the augmented reality provided via the display.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIGS. 1A and 1B are views illustrating the operation of identifying an external electronic device related to an electronic device in augmented reality provided from the electronic device according to various embodiments of the disclosure;

FIG. 2 is a block diagram illustrating an electronic device according to an embodiment of the disclosure;

FIG. 3 is a view illustrating a first identification operation in an electronic device according to an embodiment of the disclosure;

FIGS. 4A and 4B are views illustrating a second identification operation in an electronic device according to various embodiments of the disclosure;

FIGS. 5A and 5B are views illustrating a third identification operation in an electronic device according to various embodiments of the disclosure;

FIG. 6 is a flowchart illustrating the operation of identifying a relevant device in an augmented reality mode of an electronic device according to an embodiment of the disclosure;

FIGS. 7A and 7B are flowcharts illustrating the operation of identifying a relevant device in a first identification operation in an augmented reality mode of an electronic device according to various embodiments of the disclosure;

FIG. 8 is a flowchart illustrating the operation of identifying a relevant device in a second identification operation in an augmented reality mode of an electronic device according to an embodiment of the disclosure;

FIG. 9 is a flowchart illustrating the operation of identifying a relevant device in a third identification operation in an augmented reality mode of an electronic device according to an embodiment of the disclosure;

FIGS. 10A, 10B, and 10C are views illustrating the operation of identifying a relevant device in an augmented reality mode of an electronic device according to various embodiments of the disclosure;

FIGS. 11A, 11B, and 11C are views illustrating the operation of identifying a relevant device in an augmented reality mode of an electronic device according to various embodiments of the disclosure;

FIGS. 12A, 12B, and 12C are views illustrating the operation of identifying a relevant device in an augmented reality mode of an electronic device according to various embodiments of the disclosure;

FIGS. 13A and 13B are views illustrating the operation of identifying a relevant device in an augmented reality mode of an electronic device according to various embodiments of the disclosure;

FIGS. 14A and 14B are views illustrating the operation of identifying a relevant device in an augmented reality mode of an electronic device according to various embodiments of the disclosure;

FIGS. 15A, 15B, and 15C are views illustrating the operation of identifying a relevant device in an augmented reality mode of an electronic device according to various embodiments of the disclosure; and

FIGS. 16A and 16B are views illustrating the operation of identifying a relevant device in an augmented reality mode of an electronic device according to various embodiments of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

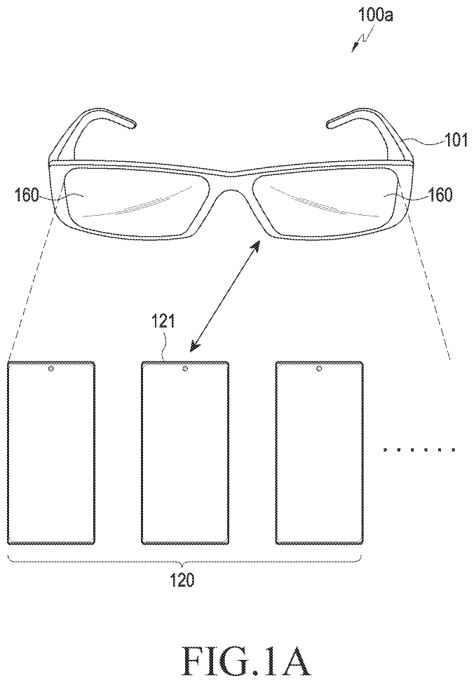

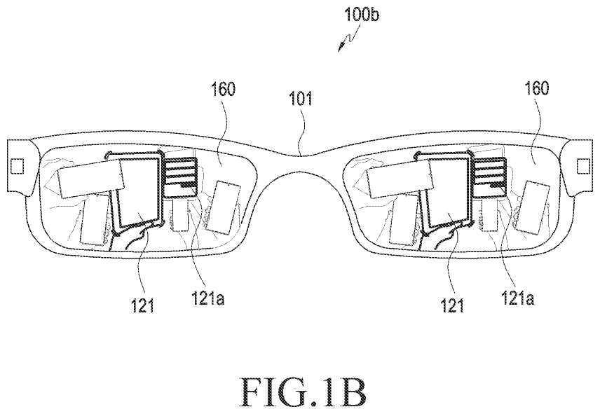

FIGS. 1A and 1B are views 100a and 100b illustrating the operation of identifying an external electronic device related to an electronic device in augmented reality provided from the electronic device according to various embodiments of the disclosure.

Referring to FIGS. 1A and 1B, while the user wears an electronic device (e.g., augmented reality (AR) glasses) providing augmented reality, the electronic device 101 may provide augmented reality via a display 160. When a plurality of external electronic devices 120 are present in the field of view of the camera of the electronic device 101, with communication established between the electronic device 101 and a first external electronic device 121, the electronic device 101 may identify the first external electronic device 121 among the plurality of external electronic devices 120 based on information obtained from the camera of the electronic device 101 and information received from the first external electronic device 121.

The electronic device 101 may overlay and display information related to the identified first external electronic device 121 on the display 160 as virtual object information 121a (e.g., an AR interface) while displaying the plurality of external electronic devices 120 via the display 160. Upon identifying the first external electronic device 121, the electronic device 101 may track the first external electronic device 121 and continuously display only information related to the first external electronic device 121, as the virtual object information 121a, in the augmented reality.

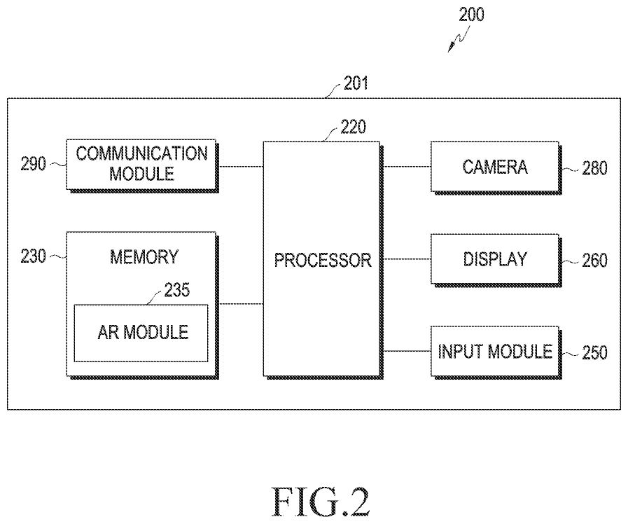

FIG. 2 is a block diagram 200 illustrating an electronic device according to an embodiment of the disclosure.

Although FIG. 2 is a block diagram of the electronic device 101 of FIGS. 1A and 1B, the block diagram of the electronic device of FIG. 2 may apply likewise to each of the plurality of external electronic devices 120 of FIG. 1A.

Referring to FIG. 2, an electronic device 201 (e.g., the electronic device 101 of FIGS. 1A and 1B) may include a processor 220, a memory 230, an input module 250, a display 260, a camera 280, and a communication module 290 (e.g., a transceiver).

According to an embodiment, the processor 220 may control the overall operation of the electronic device 201.

According to an embodiment, the processor 220 may identify a first external electronic device (e.g., the first external electronic device 121 of FIGS. 1A and 1B) which establishes communication with the electronic device 201 via the communication module 290 among at least one external electronic device (e.g., the plurality of external electronic devices 120 of FIG. 1A) present in the field of view of the camera 280 in the augmented reality provided via the display 260.

According to an embodiment, the processor 220 may perform a first identification operation using device information so as to identify the first external electronic device among the at least one external electronic device present in the field of view of the camera 280.

According to an embodiment, the processor 220 may detect a candidate external electronic device having at least one of type information, product information, visual feature information, or sensor information of the first external electronic device in the at least one external electronic device, based on device information of the first external electronic device received from the first external electronic device in the first identification operation and frame information obtained via the camera 280 and update the score for the candidate external electronic device.

According to an embodiment, the processor 220 may identify the device information (e.g., type information, product information, visual feature information, and/or sensor information) of each of the at least one external electronic device based on the frame information obtained via the camera 280.

According to an embodiment, the frame information may be an image frame obtained in real-time via the camera 280, and the frame may include at least one object corresponding to the at least one external electronic device present in the field of view of the camera 280.

According to an embodiment, the processor 220 may identify at least one of the type information, product information, visual feature information, or sensor information of the first external electronic device based on the device information of the first external electronic device, received from the first external electronic device.

According to an embodiment, the processor 220 may obtain the frame information via the camera 280 and detect, as a candidate external electronic device predictable as the first external electronic device, a first device having the same type information as the type information (e.g., a smart watch) of the first external electronic device among the at least one external electronic device in the obtained frame information. The processor 220 may identify the type information of each of the at least one external electronic device from the frame information, using such a method as convolution neural network classification or a detector algorithm. The processor 220 may update a predetermined score for the candidate external electronic device having the same type information as the type information of the first external electronic device.

According to an embodiment, the processor 220 may detect a design feature and/or logo from each of the at least one external electronic device in the frame information obtained via the camera 280 and identify the product information (manufacturer and model) corresponding to the design feature and/or logo of each of the at least one external electronic device based on device product (manufacturer and model)-related data stored in the memory 230. The processor 220 may detect, as a candidate external electronic device predictable as the first external electronic device, the first device having the same product information as the product information (e.g., Samsung AA model) of the first external electronic device among the at least one external electronic device identified based on the frame information and update a predetermined score for the candidate external electronic device.

According to an embodiment, the processor 220 may detect the type (e.g., a cover case) of the external accessory mounted on the candidate external electronic device and/or visual feature information (e.g., screen state (e.g., screen locked or unlocked state and the dominant color of the screen, and/or image type of the background screen) for each of the at least one external electronic device, based on the frame information obtained via the camera 280. The processor 220 may identify the visual feature information of the at least one external electronic device from the frame information using such a method as feature detection and/or matching algorithm. The processor 220 may detect, as a candidate external electronic device predictable as the first external electronic device, the first device having the same visual feature as the visual feature information (e.g., the dominant color of the screen which is blue) of the first external electronic device among the at least one external electronic device and update a predetermined score for the candidate external electronic device.

According to an embodiment, the processor 220 may obtain frame information via the camera 280 and detect state information (e.g., the state in which the user holds the device, the state in which the user shakes the device left and right with the device in his hand, and/or the state in which the device is worn on the user's arm) for each of the at least one external electronic device, based on the obtained frame information. The processor 220 may detect, as a candidate external electronic device predictable as the first external electronic device, the first device having the state information (e.g., the state in which the user holds the first external electronic device) corresponding to the sensor information (e.g., grip sensor information) indicating the state of the first external electronic device among the at least one external electronic device and update a predetermined score for the candidate external electronic device.

According to an embodiment, when the score obtained by the candidate external electronic device via the first identification operation is equal to or larger than an identification threshold, the processor 220 may identify the candidate external electronic device as the first external electronic device.

According to an embodiment, when the score obtained by the candidate external electronic device via the first identification operation is smaller than the identification threshold, the processor 220 may perform a second identification operation for identifying whether it is the first external electronic device, using position information.

According to an embodiment, in the second identification operation, the processor 220 may obtain first frame information including the object corresponding to the first device present in the field of view of the camera 280 via the camera 280. The processor 220 may detect a first position P1 of the first device based on the first frame information obtained via the camera 280. The first position P1 of the first device may be detected using degree-of-freedom (6DOF) technology capable of sensing movement in several directions.

The processor 220 may receive second frame information including the object corresponding to device B included in the camera field of view of the first external electronic device from the first external electronic device. The processor 220 may detect a first position P2 of device B based on the second frame information received from the first external electronic device.

The processor 220 may detect the first position P2 of device B, obtained based on the second frame information received from the first external electronic device, using 6DOF technology capable of sensing movement in several directions.

The processor 220 may convert the first position P1 of the first device into a first position P1′ corresponding to the coordinate system of device B using a coordinate conversion system. When the first position P1 of the first device is identical to the second position P1′ of the first device, converted into by the coordinate system of device B, the processor 220 may predict the first device and device B as the first external electronic device and the electronic device 201, respectively, for which communication has been established. The processor 220 may detect the first device as a candidate external electronic device predictable as the first external electronic device and update a predetermined score for the candidate external electronic device.

The processor 220 may convert the first position P2 of device B into a second position P2′ of device B corresponding to the coordinate system of the first device, using a coordinate conversion system. When the first position P2 of device B is identical to the second position P2′ of device B, converted into by the coordinate system of the first device, the processor 220 may predict the first device and device B as the first external electronic device and the electronic device 201, respectively, for which communication has been established. The processor 220 may detect the first device as a candidate external electronic device predictable as the first external electronic device and update a predetermined score for the candidate external electronic device.

According to an embodiment, the coordinate system used in the second identification operation may be performed as an algorithm capable of converting position information (e.g., coordinates) of one coordinate system into position information (e.g., coordinates) of another coordinate system.

According to an embodiment, when the total score obtained by the candidate external electronic device via the first identification operation and the second identification operation is equal to or larger than the identification threshold, the processor 220 may identify the candidate external electronic device as the first external electronic device.

According to an embodiment, when the total score obtained by the candidate external electronic device via the first identification operation and the second identification operation is smaller than the identification threshold, the processor 220 may perform a third identification operation for identifying whether the candidate external electronic device is the first external electronic device, using screen pattern information.

According to an embodiment, upon identifying that the first external electronic device includes no camera, when the candidate external electronic device obtaining the score among the at least one external electronic device via the first identification operation is smaller than the identification threshold, the processor 220 may skip the second identification operation and perform the third identification operation for identifying whether the candidate external electronic device is the first external electronic device using screen pattern information.

According to an embodiment, the processor 220 may transmit a first signal including information requesting to input specific screen pattern information to the first external electronic device for which communication has been established, in the third identification operation. The processor 220 may detect, as the candidate external electronic device, the first device, where a specific pattern has been input to the screen, among the at least one external electronic device present in the field of view of the camera 280 based on the frame information obtained via the camera 280 during a predetermined time after transmission of the first signal.

According to an embodiment, when the first signal including the information requesting to input the first pattern information, along with the first pattern information, is transmitted to the first external electronic device, the processor 220 may detect, as an external electronic device predictable as the first external electronic device, the first device where the first pattern has been input to the screen, among the at least one external electronic device present in the field of view of the camera 280 based on the frame information obtained via the camera 280.

According to an embodiment, when a first signal including information requesting to input specific pattern information is transmitted to the first external electronic device, the processor 220 may receive the first pattern information input to the screen by the user, from the first external electronic device and detect, as a candidate external electronic device predictable as the first external electronic device, the first device where the first pattern has been input to the screen, among the at least one external electronic device present in the field of view of the camera 280 based on the frame information obtained via the camera 280.

According to an embodiment, when the total score obtained by the candidate external electronic device via the first identification operation, the second identification operation, and the third identification operation is equal to or larger than the identification threshold, the processor 220 may identify the candidate external electronic device as the first external electronic device which has established communication with the electronic device 201.

According to an embodiment, when the total score obtained by the candidate external electronic device via the first identification operation, the second identification operation and the third identification operation is smaller than the identification threshold, the processor 220 may perform the first identification operation again or, as the first external electronic device having established communication with the electronic device 201 exists, request the electronic device 201 to move the position.

According to an embodiment, upon identifying the first external electronic device (e.g., the first external electronic device 121 of FIGS. 1A and 1B) which establishes communication with the electronic device 201 via the communication module 290 among at least one external electronic device (e.g., the plurality of external electronic devices 120 of FIG. 1A) present in the field of view of the camera 280 in the augmented reality provided via the display 260, the processor 220 may display information related to the first external electronic device as virtual object information.

According to an embodiment, the processor 220 may display only information related to the first external electronic device, among the at least one external electronic device, as virtual object information, while displaying the at least one external electronic device obtained via the camera 280 in the augmented reality provided via the display 260.

According to an embodiment, the processor 220 may track the identified first external electronic device and continuously display the information related to the first external electronic device as virtual object information. The processor 220 may track the position of the first external electronic device using an object tracking method.

According to an embodiment, the memory 230 may store various data used by at least one component (e.g., the processor 220 or a sensor module) of the electronic device 201. The various data may include, for example, software (e.g., the program) and input data or output data for a command related thereto. The memory 230 may include a volatile memory or a non-volatile memory. The program may be stored, as software, in the memory 230 and may include, e.g., an operating system (OS), middleware, or an application. According to an embodiment, the memory 230 may store a computer code including an augmented reality module 255, and the computer code including the augmented reality module 255 may be executed by the processor 220.

According to an embodiment, the input module 250 may receive a command or data to be used by another component (e.g., the processor 220) of the electronic device 201, from the outside (e.g., a user) of the electronic device 201. The input module 250 may include, for example, a microphone, a mouse, a keyboard, keys (e.g., buttons), or a digital pen (e.g., a stylus pen).

According to an embodiment, the display 260 may visually provide information to the outside (e.g., a user) of the electronic device 201. The display 260 may include, for example, a display, a hologram device, or a projector and control circuitry to control a corresponding one of the display, hologram device, and projector. According to an embodiment, the display 260 may include a touch sensor configured to detect a touch, or a pressure sensor configured to measure the intensity of a force generated by the touch. According to an embodiment, the display 260 may display, as a virtual object, information related to the electronic device 201 in augmented reality, e.g., information related to the external electronic device having established communication.

According to an embodiment, the camera 280 may capture a still image or moving image. According to an embodiment, the camera 280 may include one or more lenses, image sensors, image signal processors, or flashes.

According to an embodiment, the communication module 290 may support establishing a direct (e.g., wired) communication channel or wireless communication channel between the electronic device 201 and an external electronic device (e.g., the external electronic device 121 of FIGS. 1A and 1B or a server) and performing communication through the established communication channel. The communication module 290 may include one or more communication processors that are operable independently from the processor 220 (e.g., the application processor (AP)) and supports a direct (e.g., wired) communication or a wireless communication. According to an embodiment, the communication module 290 may include a wireless communication module (e.g., a cellular communication module, a short-range wireless communication module, or a global navigation satellite system (GNSS) communication module) or a wired communication module (e.g., a local area network (LAN) communication module or a power line communication (PLC) module). A corresponding one of these communication modules may communicate with the external electronic device via a first network (e.g., a short-range communication network, such as Bluetooth™, wireless-fidelity (Wi-Fi) direct, or infrared data association (IrDA)) or a second network (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other.

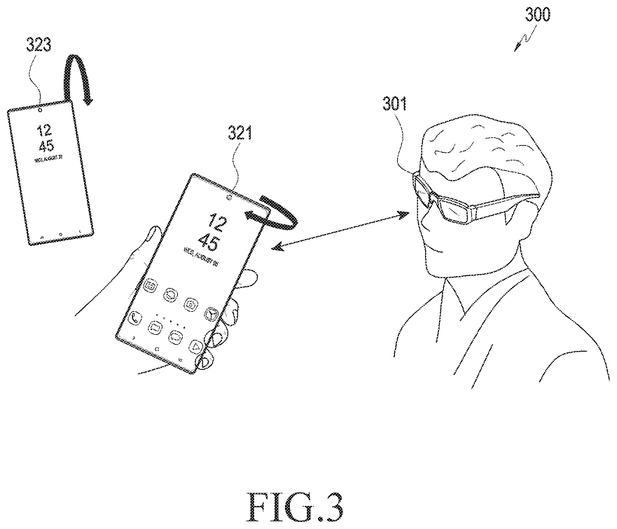

FIG. 3 is a view 300 illustrating a first identification operation in an electronic device according to an embodiment of the disclosure.

Referring to FIG. 3, an electronic device 301 (e.g., AR glasses) worn on the user's eyes may establish communication with a first external electronic device while providing augmented reality via a display (e.g., the display 260 of FIG. 2) of the electronic device 301. The electronic device 301 may perform a first identification operation for identifying a first external electronic device which has established communication, among a plurality of external electronic devices 321 and 323 present in the field of view of the camera (e.g., the camera 280 of FIG. 2) of the electronic device 301.

The electronic device 301 may obtain frame information including objects corresponding to the plurality of external electronic devices 321 and 323 via the camera of the electronic device 301 and receive device information of the first external electronic device from the communication-established first external electronic device.

The electronic device 301 may detect type information (e.g., smartphone), product information (e.g., model AA of Samsung), visual feature information (e.g., the unlocked state), and/or sensor information (e.g., the device's movement around the Y axis, with the device in the user's hand), as the device information of the first device 321 among the plurality of external electronic devices 321 and 323, based on the frame information obtained via the camera of the electronic device 301.

The electronic device 301 may detect type information (e.g., smartphone), product information (e.g., model BB of Samsung), visual feature information (e.g., the locked state), and/or sensor information (e.g., the device's movement around the X axis), as the device information of the second device 323 among the plurality of external electronic devices 321 and 323, based on the frame information obtained via the camera of the electronic device 301.

The electronic device 301 may detect type information (e.g., smartphone), product information (e.g., none), visual feature information (e.g., the unlocked state), and/or sensor information (e.g., a movement around the Y axis, with the device in the user's hand), based on the device information of the first external electronic device, received from the communication-established first external electronic device.

The electronic device 301 may compare the device information of the first device 321 of the electronic device 301 with the device information of the first external electronic device and, as a result of the comparison between the device information of the second device 323 and the device information of the first external electronic device, detect the first device 321, which has more pieces of matching information, as a candidate external electronic device predictable as the first external electronic device which has established communication with the electronic device 301. The electronic device 301 may update a predetermined score for the first device 321, which is the candidate external electronic device, corresponding to the number of the matching pieces of information of the first device 321 detected as the candidate external electronic device.

When the score obtained by the candidate external electronic device 321 via the first identification operation is equal to or larger than an identification threshold, the electronic device 301 may determine that the candidate external electronic device 321 is the first external electronic device that has established communication with the electronic device 301.

When the score obtained by the candidate external electronic device 321 via the first identification operation is smaller than the identification threshold, the electronic device 301 may perform a second identification operation for identifying the first external electronic device, using the device information.

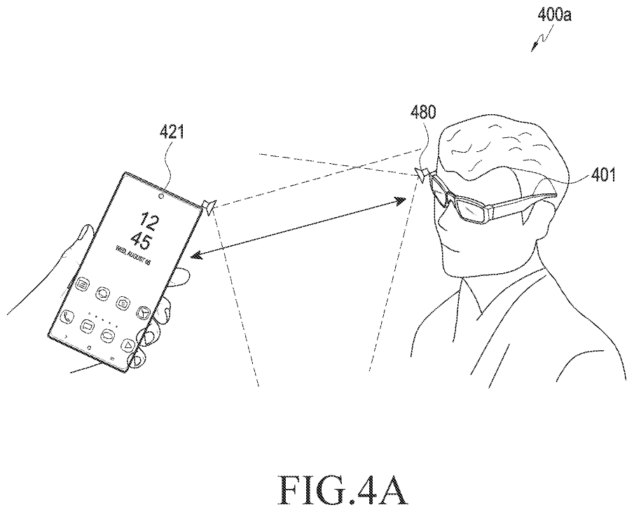

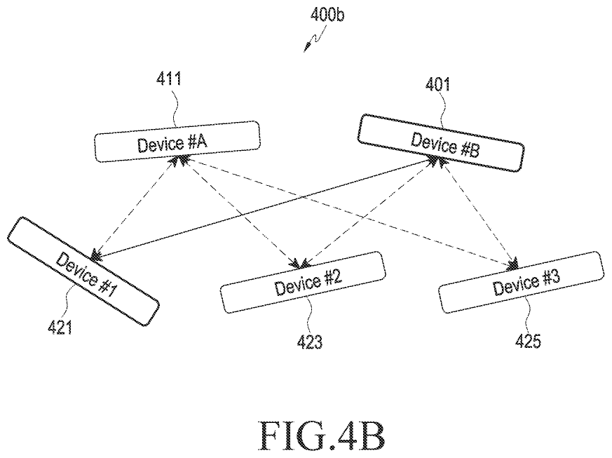

FIGS. 4A and 4B are views 400a and 400b illustrating a second identification operation in an electronic device according to various embodiments of the disclosure.

Referring to FIGS. 4A and 4B, with communication established between a first external electronic device and an electronic device 401 (e.g., AR glasses or the electronic device 301 of FIG. 3) worn on the user's eyes, the electronic device 401 may perform a second identification operation for identifying the first external electronic device which has established communication with the electronic device 401 among a plurality of external electronic devices 421, 423, and 425 present in the field of view of the camera 480.

The electronic device 401 may obtain first frame information including a plurality of objects corresponding to the plurality of external electronic devices 421, 423, and 425 present in the field of view of the camera 480 via the camera 480 (e.g., the camera 280 of FIG. 2). The electronic device 401 may detect first position information P1 (a position detected based on 6DOF technology) of a first device 421 (e.g., the first device 321 of FIG. 3), first position information P2 (a position detected based on 6DOF technology) of a second device 423, and first position information P3 (a position detected based on 6DOF technology) of a third device 425, as the position information of each of the plurality of external electronic devices 421, 423, and 425 based on the first frame information.

The electronic device 401 may receive second frame information including a plurality of objects corresponding to the plurality of external electronic devices 401 and 411 included in the field of view of the camera of the first external electronic device from the first external electronic device which has established communication. The electronic device 401 may detect a first position APR1 (a position detected based on 6DOF technology) of device A 411 and a first position APR2 (a position detected based on 6DOF technology) of device B 401, which are information of the plurality of external electronic devices 411 and 401, based on the second frame information received from the first external electronic device.

The electronic device 401 may convert the first position information ARP2 (a coordinate value) of device B 401 into second position information ARP2′ (a coordinate value) corresponding to the coordinate system of the first device 421 using a coordinate conversion program, convert the first position information ARP2 (a coordinate value) of device B 401 into third position information ARP2″ (a coordinate value) corresponding to the coordinate system of the second device 423 using the coordinate conversion program, and convert the first position information ARP2 (a coordinate value) of device B 401 into fourth position information ARP2′″ (a coordinate value) corresponding to the coordinate system of the third device 425 using the coordinate conversion program.

Upon identifying that, among the first position information APR1 of device A 411, the first position information APR2 of device B 401, the second position information ARP2′ of device B 401, converted into corresponding to the coordinate system of the first device 421, the third position information ARP2″ of device B 401, converted into corresponding to the coordinate system of the second device 423, and the fourth position information ARP2′″ of device B 401, converted into corresponding to the coordinate system of the third device 425, the coordinates of the first position ARP2 of device B 401 is identical to the coordinates of the second position ARP2′ of device B 401, converted into corresponding to the coordinate system of the first device 421, the electronic device 401 may predict device B 401 and the first device 421 as the communication-established electronic device 401 and first external electronic device, respectively. The electronic device 401 may detect the first device 421 as a candidate external electronic device predictable as the first external electronic device and update a predetermined score for the candidate external electronic device.

When the total score obtained by the candidate external electronic device 421 (e.g., the candidate external electronic device 321 of FIG. 3) via the first identification operation and second identification operation of FIG. 3 is equal to or larger than an identification threshold, the electronic device 401 may determine that the candidate external electronic device 421 is the first external electronic device that has established communication with the electronic device 401.

When the total score obtained by the candidate external electronic device 421 (e.g., the candidate external electronic device 321 of FIG. 3) via the first identification operation and second identification operation of FIG. 3 is smaller than the identification threshold, the electronic device 401 may perform a third identification operation for additionally identifying whether the candidate external electronic device 421 is the first external electronic device which has established communication with the electronic device 401.

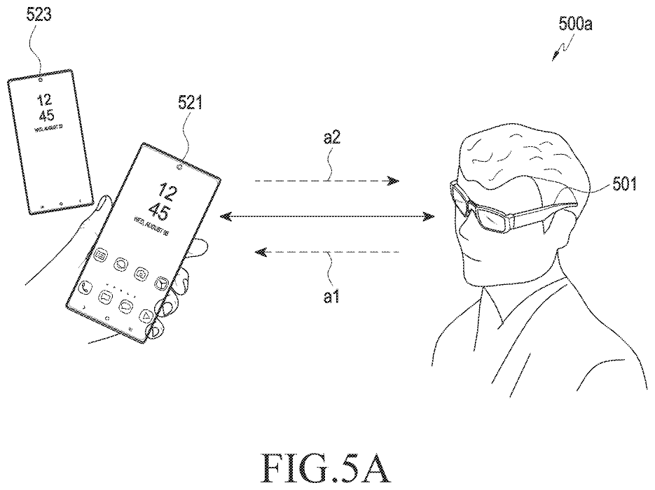

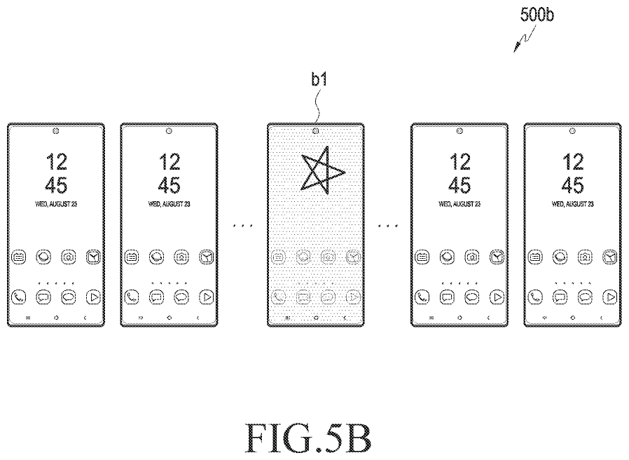

FIGS. 5A and 5B are views 500a and 500b illustrating a third identification operation in an electronic device according to various embodiments of the disclosure.

Referring to FIG. 5A, with communication established between an electronic device 501 (e.g., AR glasses or the electronic device 301 of FIG. 3 and/or the electronic device 401 of FIGS. 4A and 4B) worn on the user's eyes and a first external electronic device 521 (e.g., the first external electronic device 321 of FIG. 3 and/or the first external electronic device 421 of FIGS. 4A and 4B), the electronic device 501 may perform a third identification operation for identifying the first external electronic device which has established communication with the electronic device 501 among a plurality of external electronic devices 521 and 523 present in the field of view of the camera (e.g., the camera 280 of FIG. 2) of the electronic device 501.

The electronic device 501 may transmit a first signal to request to input a specific pattern to the screen of the first external electronic device to the communication-established first external electronic device (a1). The electronic device 501 may obtain frame information (a2) including objects corresponding to the plurality of external electronic devices 521 and 523 via the camera of the electronic device during a predetermined time after the first signal is transmitted. The electronic device 501 may identify the input of the specific pattern to the screen of the first device 521 among the plurality of external electronic devices 521 and 523 based on the frame information, predict the first device 521 as the first external electronic device, and update a predetermined score for the first device, with the first device 521 taken as the candidate external electronic device. The electronic device 501 may transmit the first signal including request information for the input of the first pattern, along with the information of the first pattern, to the first external electronic device, predict the first device 521, where the first pattern has been input to the device screen among the plurality of external electronic devices 521 and 523, as the first external electronic device, and update a predetermined score for the first device, with the first device 521 taken as the candidate external electronic device.

Upon transmitting the first signal including only the request information for the input of the specific pattern to the first external electronic device, the electronic device 501 may receive first pattern information input to the screen by the user, from the first external electronic device. The electronic device may predict, as the first external electronic device, the first device 521 where the first pattern has been input to the device screen among the plurality of external electronic devices 521 and 523, based on the frame information and update a predetermined score for the first device, with the first device 521 taken as the candidate external electronic device.

FIG. 5B shows a screen displayed on the display of the first device 521. A first pattern (e.g., a star shape) may be input to the screen of the first device 521 by the user at the time b1 of receiving the first signal from the electronic device 501.

When the total score obtained by the candidate external electronic device 521 (e.g., the candidate external electronic device 321 of FIG. 3 and/or the candidate external electronic device 421 of FIGS. 4A and 4B) via the first identification operation of FIG. 3 and the second identification operation and the third identification operation of FIGS. 4A and 4B is equal to or larger than an identification threshold, the electronic device 501 may determine that the candidate external electronic device 521 is the first external electronic device that has established communication with the electronic device 501.

When the total score obtained by the candidate external electronic device 521 (e.g., the candidate external electronic device 321 of FIG. 3 and/or the candidate external electronic device 421 of FIGS. 4A and 4B) via the first identification operation of FIG. 3 and the second identification operation and the third identification operation of FIGS. 4A and 4B is smaller than the identification threshold, the electronic device 501 may re-perform the operations from the first identification operation or, as there is no communication-established first external electronic device in the field of view of the camera of the electronic device 501, request to move the position of the electronic device.

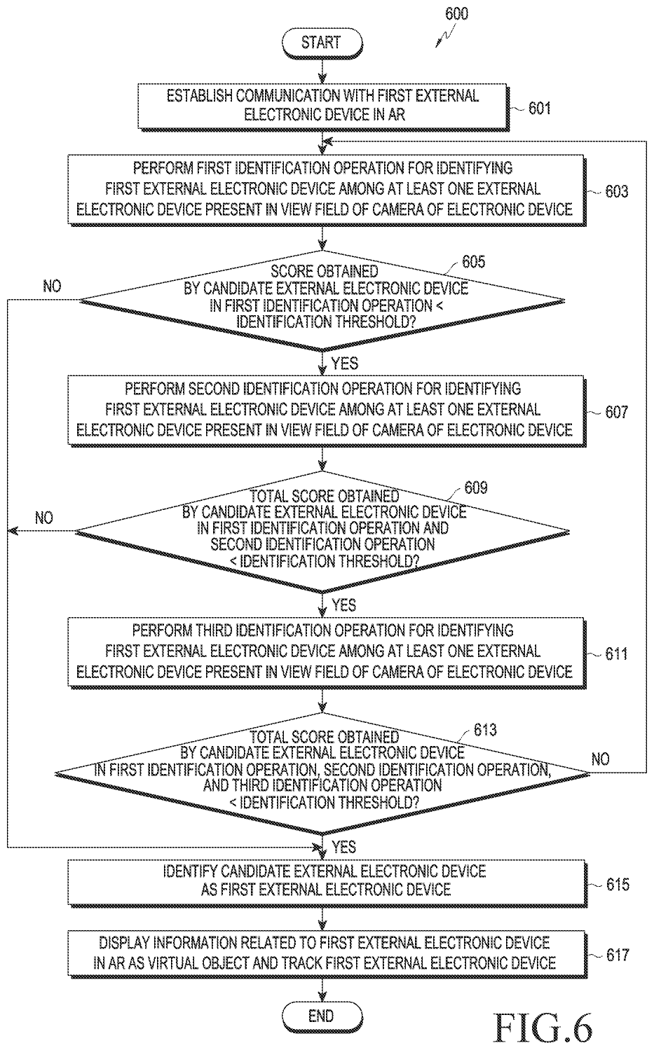

FIG. 6 is a flowchart 600 illustrating the operation of identifying a relevant device in an augmented reality mode of an electronic device according to an embodiment of the disclosure.

The operations for identifying a relevant device may include operations 601 to 617. According to an embodiment, at least one of operations 601 to 617 may be omitted or changed in order or may add other operations. The operations for identifying the relevant device may be performed by the electronic device 101 of FIGS. 1A and 1B, the electronic device 201 of FIG. 2, the processor 220 of FIG. 2, the electronic device 301 of FIG. 3, the electronic device 401 of FIGS. 4A and 4B, and/or the electronic device 501 of FIG. 5A.

In operation 601, the electronic device may establish communication with a first external electronic device via a communication module (e.g., the communication module 290 of FIG. 2) while providing augmented reality via a display (e.g., the display 260 of FIG. 2) of the electronic device.

According to an embodiment, the electronic device 201 may manually or automatically establish communication with the first external electronic device via the communication module.

In operation 603, the electronic device may perform a first identification operation for identifying the first external electronic device among at least one external electronic device present in the field of view of the camera (e.g., the camera 280 of FIG. 2) of the electronic device.

According to an embodiment, the electronic device may perform the first identification operation for identifying the first external electronic device among at least one external electronic device using device information.

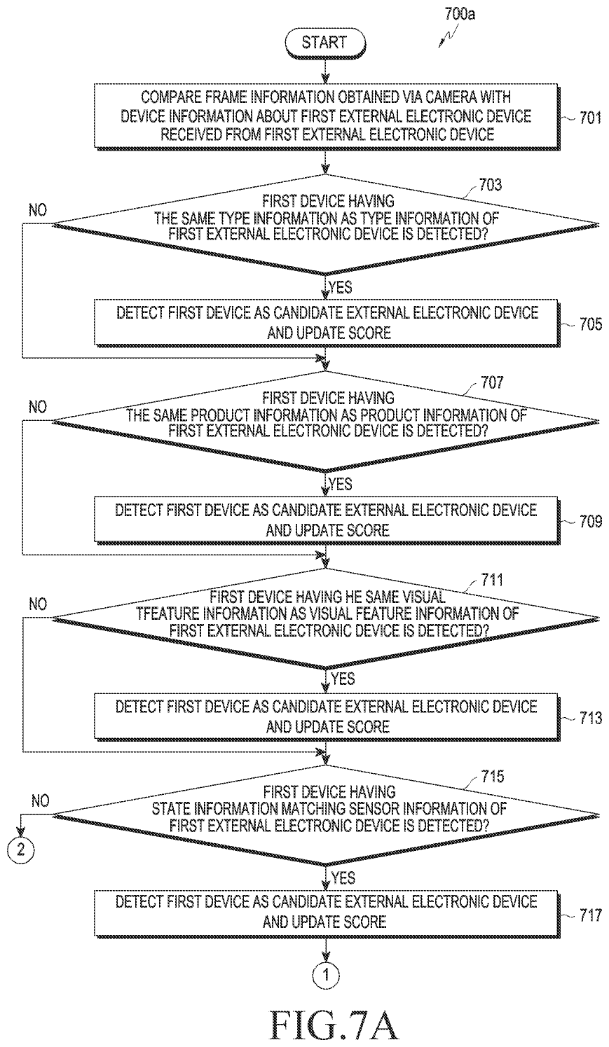

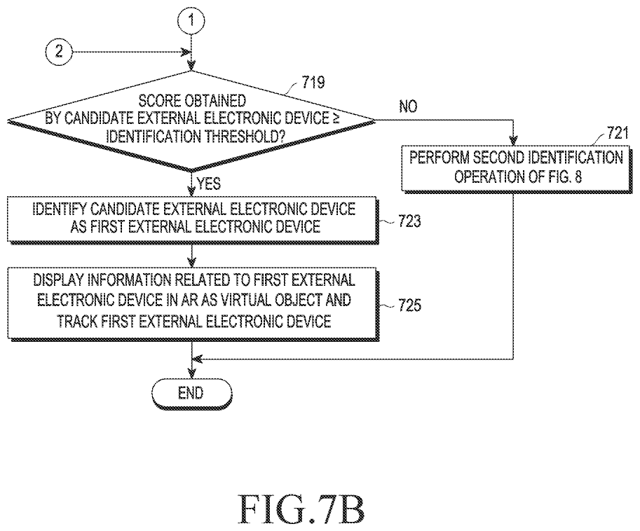

According to an embodiment, the electronic device may obtain frame information including an object corresponding to the at least one external electronic device via the camera and receive device information of the first external electronic device from the first external electronic device which has established communication. The electronic device may detect a candidate external electronic device predictable as the first external electronic device among the at least one external electronic device, based on the device information of the first external electronic device received from the first external electronic device and the frame information obtained from the camera. The first identification operation is described below in detail with reference to FIGS. 7A and 7B.

Upon determining that the score obtained by the candidate external electronic device in the first identification operation is equal to or larger than an identification threshold in operation 605, the electronic device may identify the candidate external electronic device as the first external electronic device in operation 615.

Upon determining that the score obtained by the candidate external electronic device in the first identification operation is smaller than the identification threshold in operation 605, the electronic device may perform a second identification operation for identifying the first external electronic device among at least one external electronic device present in the field of view of the camera of the electronic device in operation 607.

According to an embodiment, the electronic device may perform the second identification operation for identifying the first external electronic device among at least one external electronic device using position information.

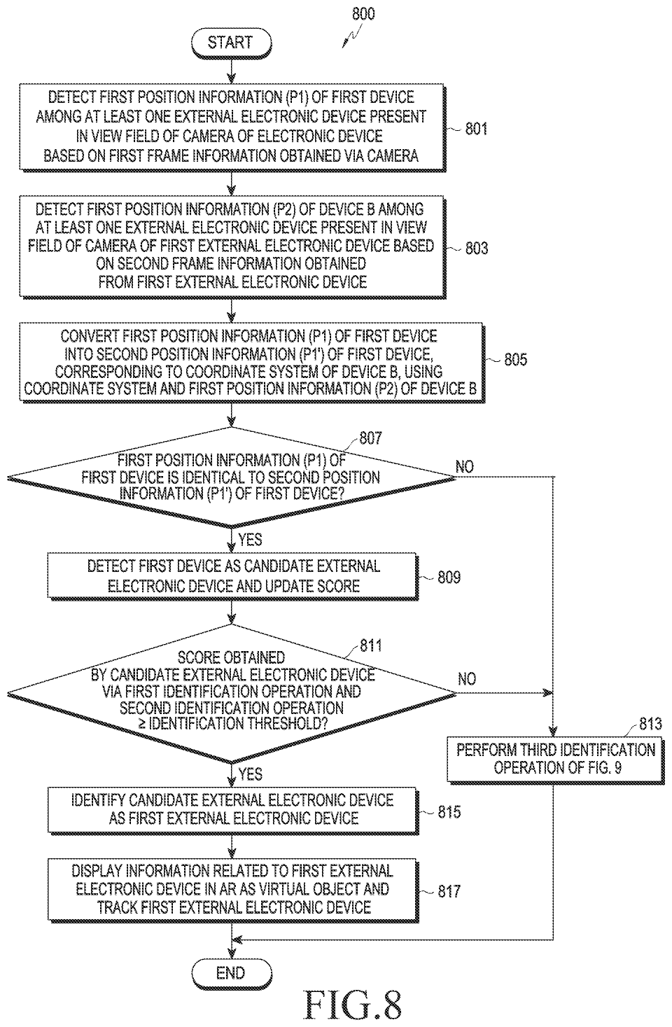

According to an embodiment, the electronic device may obtain first frame information including the object corresponding to the at least one external electronic device via the camera and receive second frame information including the object corresponding to at least one external electronic device present in the field of view of the camera of the first external electronic device, from the communication-established first external electronic device. The electronic device may detect a candidate external electronic device predictable as the first external electronic device among the at least one external electronic device, based on the position information of each of the at least one external electronic device, detected from the second frame information, and the position information of each of the at least one external electronic device, detected from the first frame information. The second identification operation is described below in detail with reference to FIG. 8.

According to an embodiment, the device with no camera, among at least one external electronic device present in the field of view of the camera of the electronic device may skip the second identification operation and may perform a third identification operation in operation 611.

Upon determining that the total score obtained by the candidate external electronic device in the first identification operation and the second identification operation is equal to or larger than the identification threshold in operation 609, the electronic device may identify the candidate external electronic device as the first external electronic device in operation 615.

Upon determining that the total score obtained by the candidate external electronic device in the first identification operation and the second identification operation is smaller than the identification threshold in operation 609, the electronic device may perform a third identification operation for identifying the first external electronic device among at least one external electronic device present in the field of view of the camera of the electronic device in operation 611.

According to an embodiment, the electronic device may perform the third identification operation for identifying the first external electronic device among at least one external electronic device using screen pattern information.

According to an embodiment, during a predetermined time after transmitting a first signal to request to input specific pattern information to the screen to the communication-established first external electronic device, the electronic device may obtain frame information including the object corresponding to the at least one external electronic device via the camera and detect the first device, where the specific pattern information has been input to the screen among the at least one external electronic device, as a candidate external electronic device predictable as the communication-established first external electronic device, based on the frame information. The third identification operation is described below in detail with reference to FIG. 9.

Upon determining that the total score obtained by the candidate external electronic device in the first identification operation, the second identification operation, and the third identification operation is smaller than the identification threshold in operation 613, the electronic device may re-perform the first identification operation of operation 603, perform the second identification operation of FIGS. 7A and 7B, or as there is no first external electronic device in the field of view of the camera of the electronic device, request the user to move the position of the electronic device.

Upon determining that the total score obtained by the candidate external electronic device in the first identification operation, the second identification operation, and the third identification operation is equal to or larger than the identification threshold in operation 613, the electronic device may identify the candidate external electronic device as the first external electronic device in operation 615.

In operation 617, the electronic device may display only information related to the first external electronic device in the augmented reality provided via the display of the electronic device as virtual object information and track the first external electronic device.

According to an embodiment, the electronic device may display only the information related to the identified first external electronic device among the at least one external electronic device in the augmented reality provided via the display of the electronic device, as virtual object information.

According to an embodiment, the electronic device may track the movement of the identified first external electronic device and continuously display the information related to the first external electronic device as virtual object information.

FIGS. 7A and 7B are flowcharts 700a and 700b illustrating the operation of identifying a relevant device in a first identification operation in an augmented reality mode of an electronic device according to various embodiments of the disclosure.

The operations for identifying a relevant device may include operations 701 to 725. According to an embodiment, at least one of operations 701 to 725 may be omitted or changed in order or may add other operations. The operations for identifying the relevant device may be performed by the electronic device 101 of FIGS. 1A and 1B, the electronic device 201 of FIG. 2, the processor 220 of FIG. 2, the electronic device 301 of FIG. 3, the electronic device 401 of FIGS. 4A and 4B, and/or the electronic device 501 of FIG. 5A.

In operation 701, the electronic device may compare the frame information obtained via the camera (e.g., the camera 280 of FIG. 2) of the electronic device with device information of the first external electronic device from the communication-established first external electronic device.

According to an embodiment, the electronic device may establish communication with the first external electronic device via a communication module (e.g., the communication module 290 of FIG. 2) while providing augmented reality via a display (e.g., the display 260 of FIG. 2) to the user.

According to an embodiment, the electronic device may obtain frame information including the object corresponding to at least one external electronic device (e.g., the at least one external electronic device 321 and 323 of FIG. 3) present in the field of view of the camera via the camera (e.g., the camera 280 of FIG. 2) and detect device information (e.g., type information, product information, visual feature information, and/or sensor information) of each of the at least one external electronic device, based on the obtained frame information. The electronic device may receive the device information of the first external electronic device (e.g., the type information, product information, visual feature information, and/or sensor information of the first external electronic device) from the communication-established first external electronic device. The electronic device may compare the device information of each of the at least one external electronic device, detected based on the frame, with the device information of the first external electronic device, received from the first external electronic device.

In operation 703, the electronic device may detect the first device having the same type information as the type information (e.g., smart watch) of the first external electronic device.

According to an embodiment, the electronic device may detect the first device (e.g., the first device 321 of FIG. 3) having the same type information as the type information of the first external electronic device among the at least one external electronic device.

Upon failing to detect a device having the same type information as the type information of the first external electronic device among the at least one external electronic device in operation 703, the electronic device may perform operation 707 without obtaining the score.

In operation 705, the electronic device may detect the first device as a candidate external electronic device predictable as the first external electronic device and update the score for the first device.

According to an embodiment, the electronic device may transmit a predetermined score according to a match in type information to the candidate external electronic device.

In operation 707, the electronic device may detect the first device having the same product information as the product information (model or manufacturer) of the first external electronic device.

According to an embodiment, the electronic device may detect the first device (e.g., the first device 321 of FIG. 3) having the same product information as the product information of the first external electronic device among the at least one external electronic device.

Upon failing to detect a device having the same product information as the product information of the first external electronic device among the at least one external electronic device in operation 707, the electronic device may perform operation 711 without obtaining the score.

In operation 709, the electronic device may detect the first device as a candidate external electronic device predictable as the first external electronic device and update the score for the first device.

According to an embodiment, the electronic device may transmit a predetermined score according to a match in product information to the candidate external electronic device.

In operation 711, the electronic device may detect the first device having the same visual feature information as the visual feature information (e.g., the dormant color of the screen which is blue) of the first external electronic device.

According to an embodiment, upon detecting the first device (e.g., the first device 321 of FIG. 3) having the same visual feature information as the visual feature information of the first external electronic device among the at least one external electronic device, the electronic device may detect the first device as a candidate external electronic device predictable as the first external electronic device.

Upon failing to detect a device having the same visual feature information as the visual feature information of the first external electronic device among the at least one external electronic device in operation 711, the electronic device may perform operation 715 without obtaining the score.

In operation 713, the electronic device may detect the first device as the candidate external electronic device and update the score for the first device.

According to an embodiment, the electronic device may transmit a predetermined score according to a match in visual feature information to the candidate external electronic device.

In operation 715, the electronic device may detect the first device having the state information corresponding to the sensor information of the first external electronic device.

According to an embodiment, the electronic device may detect sensor information (e.g., grip sensor information and/or accelerometer information) from the device information of the first external electronic device and may detect the state information (e.g., the state in which the user grips the first external electronic device and/or the state in which the user shakes the first external electronic device with the first external electronic device in his hand) of the first device (e.g., the second device 321 of FIG. 3) among at least one electronic device based on the frame information.

Upon failing to detect a device having the state information corresponding to the sensor information of the first external electronic device among the at least one external electronic device in operation 715, the electronic device may compare the score obtained by the candidate external electronic device with an identification threshold in operation 719.

In operation 717, the electronic device may detect the first device as a candidate external electronic device predictable as the first external electronic device and update the score for the first device.

In operation 719, the electronic device may compare the score obtained by the first device, which is the candidate external electronic device, with the identification threshold and, as a result of the comparison, when the score obtained by the candidate external electronic device is equal to or larger than the identification threshold, the electronic device may identify the candidate external electronic device as the first external electronic device in operation 723.

When the score obtained by the candidate external electronic device is smaller than the identification threshold in operation 719, the electronic device may perform the second identification operation of FIG. 8 in operation 721.

In operation 725, the electronic device may display only information related to the first external electronic device in the augmented reality provided via the display as virtual object information and track the first external electronic device.

According to an embodiment, the electronic device may display only the information related to the identified first external electronic device among the at least one external electronic device in the augmented reality provided via the display of the electronic device, as virtual object information.

According to an embodiment, the electronic device may track the movement of the identified first external electronic device and continuously display the information related to the first external electronic device as virtual object information.

FIG. 8 is a flowchart 800 illustrating the operation of identifying a relevant device in a second identification operation in an augmented reality mode of an electronic device according to an embodiment of the disclosure.

The operations for identifying a relevant device may include operations 801 to 817. According to an embodiment, at least one of operations 801 to 817 may be omitted or changed in order or may add other operations. The operations for identifying the relevant device may be performed by the electronic device 101 of FIGS. 1A and 1B, the electronic device 201 of FIG. 2, the processor 220 of FIG. 2, the electronic device 301 of FIG. 3, the electronic device 401 of FIGS. 4A and 4B, and/or the electronic device 501 of FIG. 5A.

In operation 801, the electronic device may detect first position information P1 of a first device among at least one external electronic device present in the field of view of the camera of the electronic device, based on first frame information obtained via the camera (e.g., the camera 280 of FIG. 2) of the electronic device.

According to an embodiment, the electronic device may establish communication with the first external electronic device via a communication module (e.g., the communication module 290 of FIG. 2) while providing augmented reality via a display (e.g., the display 260 of FIG. 2) to the user.

According to an embodiment, the electronic device may detect the first position information e.g., P1, P2, or P3) of each of the at least one external electronic device (e.g., the at least one external electronic device 421, 423, and 425 of FIGS. 4A and 4B) present in the field of view of the camera of the electronic device, based on the first frame information obtained via the camera of the electronic device. The electronic device may detect the first position information P1 of the first device (e.g., the first device 421 of FIGS. 4A and 4B) of the position information of each of the at least one external electronic device.

In operation 803, the electronic device may detect the first position information P2 of device B (e.g., 401 of FIGS. 4A and 4B) among at least one external electronic device (e.g., 401 and 411 of FIGS. 4A and 4B) present in the field of view of the camera of the first external electronic device, based on the second frame information obtained from the first external electronic device.

According to an embodiment, the electronic device may detect the first position information of each of the at least one external electronic device (e.g., the at least one external electronic device 401 and 411 of FIGS. 4A and 4B) present in the field of view of the camera of the first external electronic device, based on the second frame information received from the first external electronic device. The electronic device may detect the position information P2 of device B (e.g., device B 401 of FIGS. 4A and 4B) of the first position information of each of the at least one external electronic device.

In operation 805, the electronic device may convert the first position information P1 (coordinates) of the first device into second position information P1′ (coordinates) of the first device corresponding to the coordinate system of device B, using a coordinate conversion system.

When the first position information P1 of the first device is identical to the second position information P1′ of the first device in operation 807, the electronic device may predict device B and the first device as the electronic device and the first external electronic device having established communication and, in operation 809, the electronic device may detect the first device as a candidate external electronic device and update the score for the candidate external electronic device.

According to an embodiment, the electronic device may convert the first position information P2 (coordinates) of device B into the second position information P2′ (coordinates) of device B corresponding to the coordinate system of the first device, using the coordinate conversion system. When the first position information P2 of device B is identical to the second position information P2′ of device B, the electronic device may predict device B and the first device as the electronic device and the first external electronic device having established communication and may detect the first device as a candidate external electronic device and update the score for the candidate external electronic device.

Unless the first position information P1 of the first device is identical to the second position information P1′ of the first device in operation 807, the electronic device may perform the third identification operation of FIG. 9 in operation 813.

According to an embodiment, unless the first position information P2 of device B is identical to the second position information P2′ of device B, the electronic device may perform the third identification operation of FIG. 9.

In operation 811, the electronic device may compare the score obtained by the candidate external electronic device, with the identification threshold and, as a result of the comparison, when the score obtained by the candidate external electronic device is equal to or larger than the identification threshold, the electronic device may identify the candidate external electronic device as the first external electronic device in operation 815.

According to an embodiment, the electronic device may compare the total score obtained by the candidate external electronic device in the first identification operation of FIGS. 7A and 7B and operation 809 with the identification threshold.

When the score obtained by the candidate external electronic device is smaller than the identification threshold in operation 811, the electronic device may perform the third identification operation of FIG. 9 in operation 813.

In operation 817, the electronic device may display only information related to the first external electronic device in the augmented reality provided via the display as virtual object information and track the first external electronic device.

According to an embodiment, the electronic device may display only the information related to the identified first external electronic device among the at least one external electronic device in the augmented reality provided via the display of the electronic device, as virtual object information.

According to an embodiment, the electronic device may track the movement of the identified first external electronic device and continuously display the information related to the first external electronic device as virtual object information.

FIG. 9 is a flowchart 900 illustrating the operation of identifying a relevant device in a third identification operation in an augmented reality mode of an electronic device according to an embodiment of the disclosure.

The operations for identifying the relevant device may include operations 901 to 913. According to an embodiment, at least one of operations 901 to 913 may be omitted or changed in order or may add other operations. The operations for identifying the relevant device may be performed by the electronic device 101 of FIGS. 1A and 1B, the electronic device 201 of FIG. 2, the processor 220 of FIG. 2, the electronic device 301 of FIG. 3, the electronic device 401 of FIGS. 4A and 4B, and/or the electronic device 501 of FIG. 5A.

In operation 901, the electronic device may transmit a first signal to request to input specific pattern information to the screen to the first external electronic device.

According to an embodiment, the electronic device may establish communication with the first external electronic device via a communication module (e.g., the communication module 290 of FIG. 2) while providing augmented reality via a display (e.g., the display 260 of FIG. 2) to the user.

According to an embodiment, the electronic device may transmit request information for the input of the first pattern, along with the information of the first pattern, to the first external electronic device.

According to an embodiment, the electronic device may transmit the first signal including only the request information for the input of the specific pattern to the first external electronic device.

In operation 903, the electronic device may detect the first device, where screen pattern information has been input to the screen, among at least one external electronic device, based on frame information obtained via the camera.

According to an embodiment, the electronic device may obtain the frame via the camera during a predetermined time after transmitting the first signal.

According to an embodiment, the electronic device may detect the first device (e.g., the first device 521 of FIG. 5A), where the screen pattern information has been input, as a result of identifying the device where the screen pattern information has been input to the screen of each of at least one external electronic device (e.g., the at least one external electronic device 521 and 523 of FIG. 5A), based on the frame information obtained via the camera.

According to an embodiment, the electronic device may detect the first device, where first pattern information has been input to the screen by the user, in response to the first signal including the request information for the input of the first pattern along with the information of the first pattern.

According to an embodiment, in response to the first signal including only the request information for the input of the screen pattern information, the electronic device may receive the first pattern information input to the screen of the first external electronic device by the user from the first external electronic device and detect the first device where the first pattern information has been input to the screen among the at least one external electronic device.

In operation 905, the electronic device may detect the first device as the candidate external electronic device and update the score for the first device.

In operation 907, the electronic device may compare the score obtained by the candidate external electronic device, with the identification threshold and, as a result of the comparison, when the score obtained by the candidate external electronic device is equal to or larger than the identification threshold, the electronic device may identify the candidate external electronic device as the first external electronic device in operation 911.

According to an embodiment, the electronic device may compare the total score obtained by the candidate external electronic device in the first identification operation of FIGS. 7A and 7B, the second identification operation of FIG. 8, and operation 905 with the identification threshold.

When the score obtained by the candidate external electronic device is smaller than the identification threshold in operation 907, the electronic device may, in operation 909, perform the first identification operation of FIG. 6 or, as there is no communication-established first external electronic device in the field of view of the camera of the electronic device, request the user to move the position of the electronic device.

In operation 913, the electronic device may display only information related to the first external electronic device in the augmented reality provided via the display as virtual object information and track the first external electronic device.

According to an embodiment, the electronic device may display only the information related to the identified first external electronic device among the at least one external electronic device in the augmented reality provided via the display of the electronic device, as virtual object information.

According to an embodiment, the electronic device may track the movement of the identified first external electronic device and continuously display the information related to the first external electronic device as virtual object information.

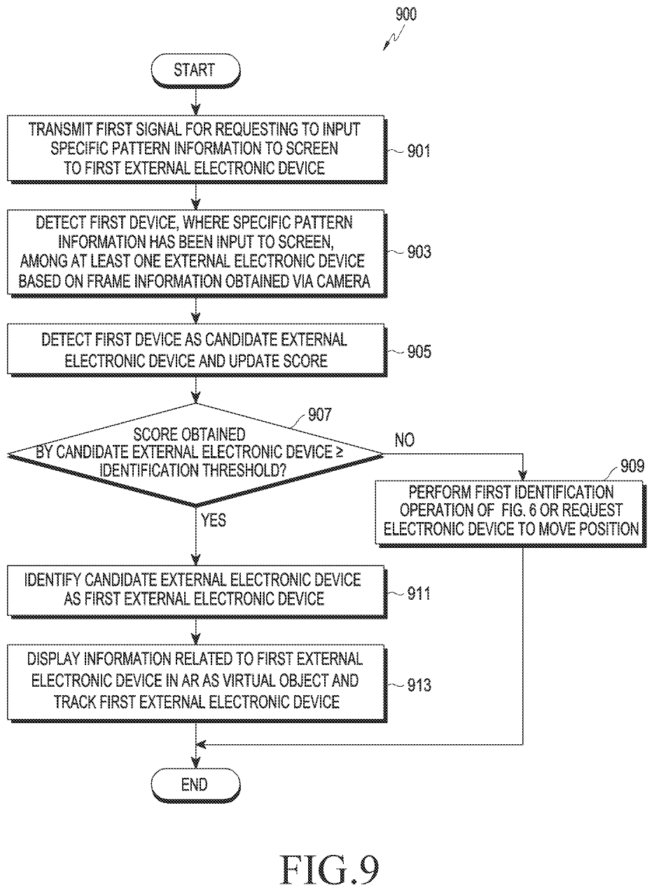

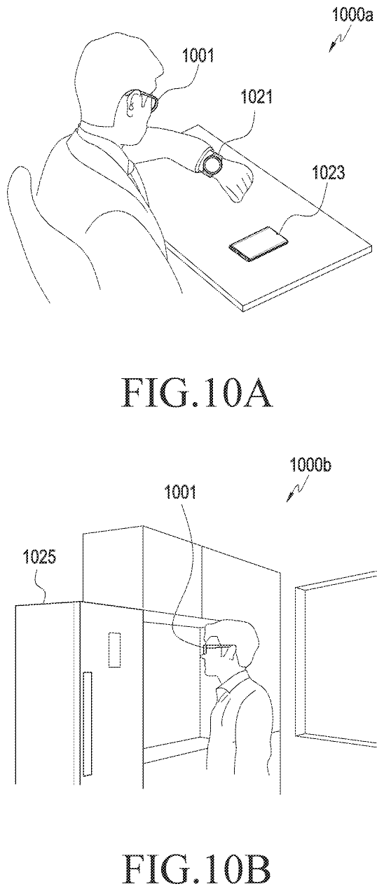

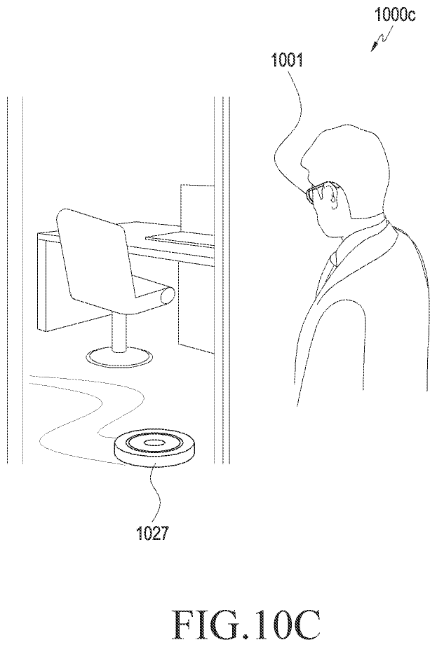

FIGS. 10A, 10B, and 10C are views 1000a, 1000b, and 1000c illustrating the operation of identifying a relevant device in an augmented reality mode of an electronic device according to various embodiments of the disclosure.

Referring to FIG. 10A, an electronic device 1001 (e.g., AR glasses) worn on the user's eyes may establish communication with a first external electronic device while providing augmented reality via a display. The electronic device 1001 may perform a first identification operation for identifying a first external electronic device which has established communication, among a plurality of external electronic devices 1021 and 1023 present in the field of view (FOV) of the camera of the electronic device 1001.

The electronic device 1001 may obtain frame information including objects corresponding to the plurality of external electronic devices 1021 and 1023 present in the field of view (FOV) of the camera of the electronic device 1001 and receive device information of the first external electronic device from the communication-established first external electronic device.

The electronic device 1001 may detect a device having at least one matching information of the type information (e.g., smart watch), product information (e.g., model AA of Samsung), visual feature information (e.g., the dominant screen color which is blue), or sensor information (compass sensor information) of the first external electronic device, among the plurality of external electronic devices 1021 and 1023, based on the frame information obtained from the camera of the electronic device and the device information of the first external electronic device obtained from the first external electronic device. Table 1 below shows resultant data according to the first identification operation. The first device 1021 may be detected as a candidate external electronic device predictable as the first external electronic device, among the plurality of external electronic devices 1021 and 1023, based on Table 1.

TABLE 1

| | first | | second | |
|---|---|---|---|---|
| device information | device 1021 | | device 1023 | |
| type information | smart watch | +0.1 | smartphone | 0 |
| product information | not detected | 0 | not detected | 0 |
| visual feature | dominant screen | +0.2 | not detected | 0 |
| information | color which is | | | |
| | blue | | | |
| sensor information | compass mode | +0.2 | not detected | 0 |

As the score (e.g., 0.5) of the first device 1023 determined to be the candidate external electronic device based on Table 1 is smaller than an identification threshold (e.g., 1.0), the electronic device may perform a second identification operation. The electronic device may detect the position information P1 of the first device based on the first frame information obtained via the camera of the electronic device through the second identification operation using position information and may detect the position information p2 of device B based on the second frame information received from the first external electronic device. When the first position information P1 of the first device is identical to the second position information P1′ of the first device, which is resultant from converting the position information P1 of the first device to correspond to the coordinate system of device B or when the first position information P2 of device B is identical to the second position information P2′ of device B, which is resultant from converting the position information P2 of device B to correspond to the coordinate system of the first device, the electronic device may predict device B and the first device as communication-established electronic device 1001 and first external electronic device and thus detect them as candidate external electronic devices and may update the score for the first device by “+0.5.”

As the total score (e.g., 1.0) of the first device 1021, the candidate external electronic device, which is the sum of the score (0.5) obtained in the first identification operation and the score (0.5) obtained in the second identification operation is identical to the identification threshold (e.g., 1.0), the electronic device may identify the first device 1021 as the first external electronic device having established communication with the electronic device 1001.

Referring to FIG. 10B, an electronic device 1001 (e.g., AR glasses) worn on the user's eyes may establish communication with a first external electronic device while providing augmented reality via a display. The electronic device 1001 may perform the first identification operation for identifying whether a refrigerator 1025 present in the field of view (FOV) of the camera of the electronic device 1001 is the communication-established first external electronic device.

The electronic device 1001 may obtain frame information including the object corresponding to the refrigerator 1025 present in the field of view (FOV) of the camera of the electronic device 1001 and receive device information of the first external electronic device from the communication-established first external electronic device.

The electronic device 1001 may detect whether the device information of the refrigerator 1025 matches at least one of the type information (e.g., refrigerator), product information (e.g., Samsung RT26 model), visual feature information (e.g., a specific sticker and magnet), or sensor information (no information), based on the frame information obtained from the camera of the electronic device and the device information of the first external electronic device obtained from the first external electronic device. Table 2 below shows resultant data according to the first identification operation. The refrigerator 1025 may be detected as a candidate external electronic device predictable as the first external electronic device based on Table 2.

TABLE 2

| device information | first device 1025 | |
|---|---|---|
| type information | refrigerator | +0.1 |
| product information | Samsung RT-26 | +0.2 |
| visual feature | a specific sticker and magnet attached | +0.2 |
| information | to the outside of the refrigerator | |
| sensor information | not detected | 0 |

As the score (e.g., 0.5) of the refrigerator 1025 determined to be the candidate external electronic device based on Table 2 is smaller than an identification threshold (e.g., 1.0), the electronic device may perform the second identification operation. The electronic device may recognize that the refrigerator lacks a camera, skip the second identification operation, and perform the third identification operation.

The electronic device may detect, as the frame information via the camera, information indicating whether a light emitting device (LED) of the refrigerator blinks during a predetermined time, via the third identification operation using screen pattern information and, when the LED blinking during the predetermined time matches preset screen pattern information, predict the refrigerator 1025 as the first external electronic device and detect it as a candidate external electronic device and may update the score for the refrigerator 1025 by “+0.5.”

As the total score (e.g., 1.0) of the refrigerator 1025, the candidate external electronic device, which is the sum of the score (0.5) obtained in the first identification operation and the score (0.5) obtained in the third identification operation is identical to the identification threshold (e.g., 1.0), the electronic device may identify the refrigerator 1025 as the first external electronic device having established communication with the electronic device 1001.

Referring to FIG. 10C, an electronic device 1001 (e.g., AR glasses) worn on the user's eyes may establish communication with a first external electronic device while providing augmented reality via a display. The electronic device 1001 may perform the first identification operation for identifying whether a robot vacuum 1027 present in the field of view (FOV) of the camera of the electronic device 1001 is the communication-established first external electronic device.

The electronic device 1001 may obtain frame information including the object corresponding to the robot vacuum 1027 present in the field of view (FOV) of the camera of the electronic device 1001 and receive device information of the first external electronic device from the communication-established first external electronic device.

The electronic device 1001 may detect whether the device information of the robot vacuum 1027 matches at least one of the type information (e.g., robot vacuum), product information (e.g., Samsung POWERbot), visual feature information (e.g., no information), or sensor information (acceleration information), based on the frame information obtained from the camera of the electronic device and the device information of the first external electronic device obtained from the first external electronic device. Table 3 below shows resultant data according to the first identification operation. The robot vacuum 1027 may be detected as a candidate external electronic device predictable as the first external electronic device based on Table 3.

TABLE 3

| device information | first device 1027 | |
|---|---|---|
| type information | robot vacuum | +0.1 |
| product information | Samsung POWERbot | +0.3 |
| visual feature information | not detected | 0 |
| sensor information | moving state | +0.6 |

As the score (e.g., 1.0) of the robot vacuum 1027, determined to be the candidate external electronic device based on Table 3 is identical to the identification threshold (e.g., 1.0), the electronic device may identify the robot vacuum 1027 as the first external electronic device having established communication with the electronic device 1001.

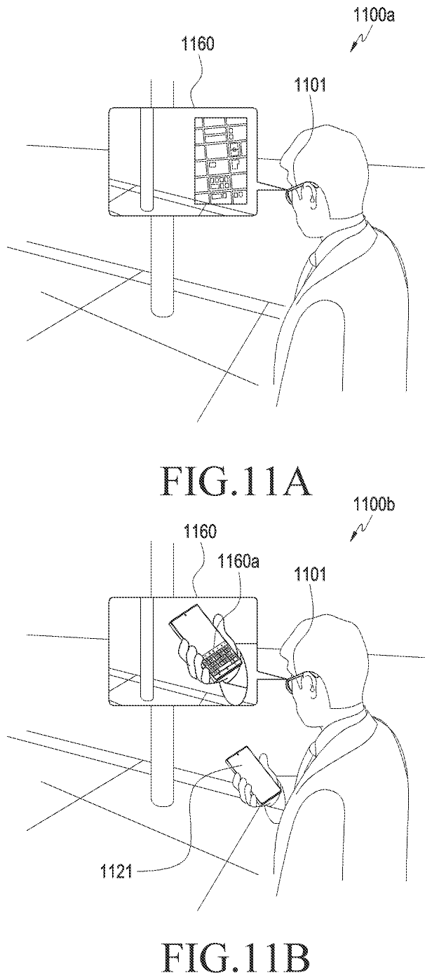

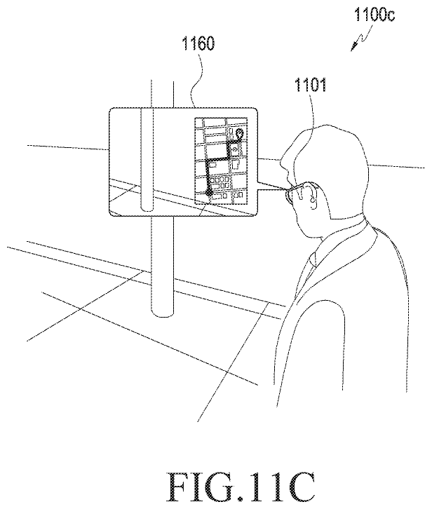

FIGS. 11A, 11B, and 11C are views 1100a, 1100b, and 1100c illustrating the operation of identifying a relevant device in an augmented reality mode of an electronic device according to various embodiments of the disclosure.

Referring to FIG. 11A, an electronic device 1101 (e.g., AR glasses) worn on the user's eyes may execute a map application in augmented reality when the map application is selected while providing the augmented reality via a display 1160.

Referring to FIG. 11B, when the user holds the first external electronic device 1121 (e.g., a smartphone), which has established communication with the electronic device 1101, and looks at the first external electronic device to input a destination while the map application is running in the augmented reality, the electronic device 1101 may identify the first device 1121 present in the field of view of the camera of the electronic device 1101 as the first external electronic device via at least one identification operation of the first identification operation of FIGS. 7A and 7B, the second identification operation of FIG. 8, and/or the third identification operation of FIG. 9 and display information 1160a (e.g., a keyword for inputting the destination) related to the first external electronic device as virtual object information.

Referring to FIG. 11C, after the user inputs the destination via the keyword of the first external electronic device, and when the first external electronic device 1121 disappears from the field of view of the camera of the electronic device, the electronic device 1101 may display a direction to the destination on the map application via augmented reality.

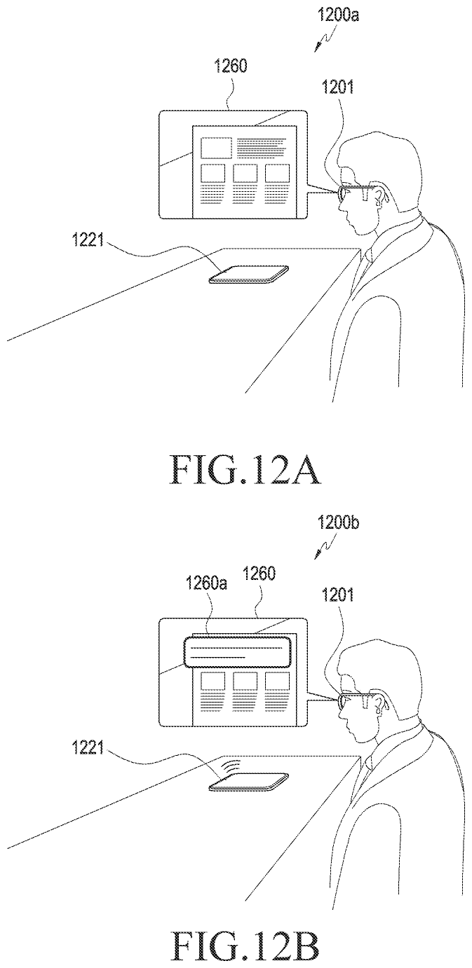

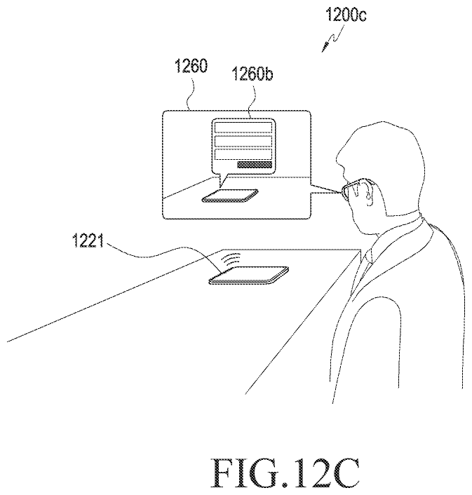

FIGS. 12A, 12B, and 12C are views 1200a, 1200b, and 1200c illustrating the operation of identifying a relevant device in an augmented reality mode of an electronic device according to various embodiments of the disclosure.

Referring to FIG. 12A, an electronic device 1201 (e.g., AR glasses) worn on the user's eyes may execute an Internet application in augmented reality when the Internet application is selected while providing the augmented reality via a display 1260.

Referring to FIG. 12B, upon receiving information indicating reception of a message from the first external electronic device having established communication with the electronic device 1201 while the Internet application is running in augmented reality, the electronic device 1201 may display a notification 1260a to indicate the reception of the message at the top of the display 1260.

Referring to FIG. 12C, when the first device 1221 is present in the field of view of the camera of the electronic device 1201 as the user wearing the electronic device 1201 moves, the electronic device 1201 may identify the first device 1221 present in the field of view of the camera of the electronic device 1201 as the first external electronic device, via at least one identification operation of the first identification operation of FIGS. 7A and 7B, the second identification operation of FIG. 8, and/or the third identification operation of FIG. 9 and display information 1260b (e.g., the whole content of the message) related to the first external electronic device as virtual object information.

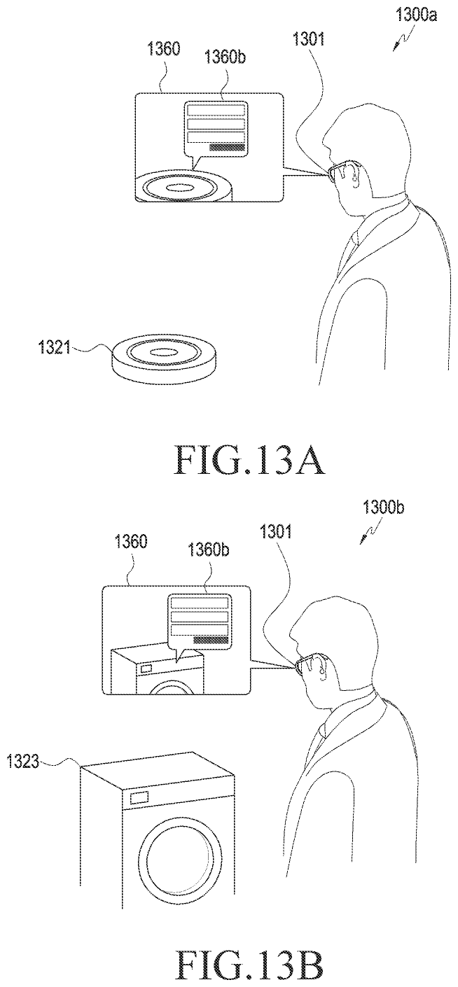

FIGS. 13A and 13B are views 1300a and 1300b illustrating the operation of identifying a relevant device in an augmented reality mode of an electronic device according to various embodiments of the disclosure.

Referring to FIG. 13A, when the robot vacuum 1321 is present in the field of view of the camera of the electronic device 1301 while providing augmented reality via the display 1360, the electronic device 1301 (e.g., AR glasses) worn on the user's eyes may identify the robot vacuum 1321 as the first external electronic device having established communication with the electronic device 1301 via at least one identification operation of the first identification operation of FIGS. 7A and 7B, the second identification operation of FIG. 8, and/or the third identification operation of FIG. 9 and display information 1360b (e.g., the state information of the robot vacuum) related to the robot vacuum 1321 as virtual object information.

Referring to FIG. 13B, when a washer 1323 is present in the field of view of the camera of the electronic device 1301 while providing augmented reality via the display 1360, the electronic device 1301 (e.g., AR glasses) worn on the user's eyes may identify the washer 1323 as the first external electronic device having established communication with the electronic device 1301 via at least one identification operation of the first identification operation of FIGS. 7A and 7B, the second identification operation of FIG. 8, and/or the third identification operation of FIG. 9 and display information 1360b (e.g., the state information of the washer) related to the washer 1323 as virtual object information.

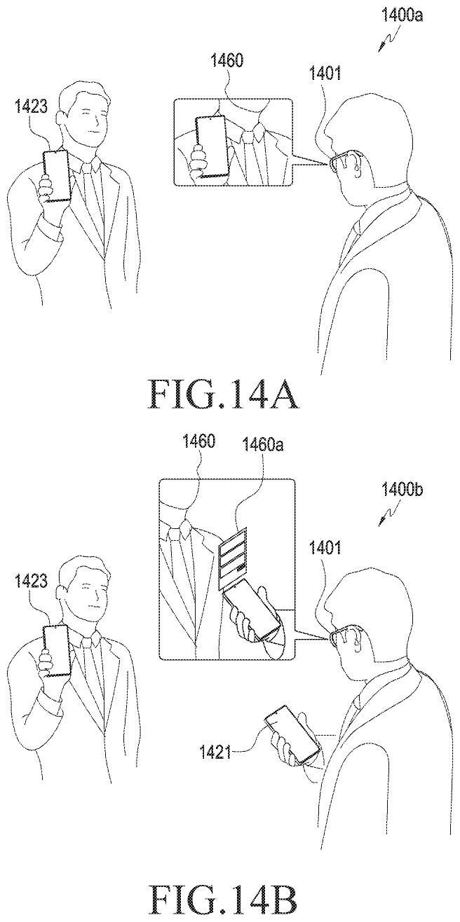

FIGS. 14A and 14B are views 1400a and 1400b illustrating the operation of identifying a relevant device in an augmented reality mode of an electronic device according to various embodiments of the disclosure.

Referring to FIG. 14A, unless the second device 1423 is identified as the first external electronic device having established communication with the electronic device 1401 (e.g., AR glasses) worn on the user's eyes, via at least one identification operation of the first identification operation of FIGS. 7A and 7B, the second identification operation of FIG. 8, and/or the third identification operation of FIG. 9 although another second device 1423 (e.g., a smartphone) of the user is present in the field of view of the camera of the electronic device 1401 while providing augmented reality via the display 1460, the electronic device 1401 does not display the information related to the second device 1423 as virtual object information.

Referring to FIG. 14B, when the user pulls the first device 1241 (e.g., a smartphone) out of the pocket and looks at the first device 1241, the electronic device 1401 may identify the first device 1421, present in the field of view of the camera of the electronic device 1401, as the first external electronic device having established communication with the electronic device 1401, via at least one identification operation of the first identification operation of FIGS. 7A and 7B, the second identification operation of FIG. 8, and/or the third identification operation of FIG. 9 and display the information 1460a related to the first external electronic device as virtual object information.

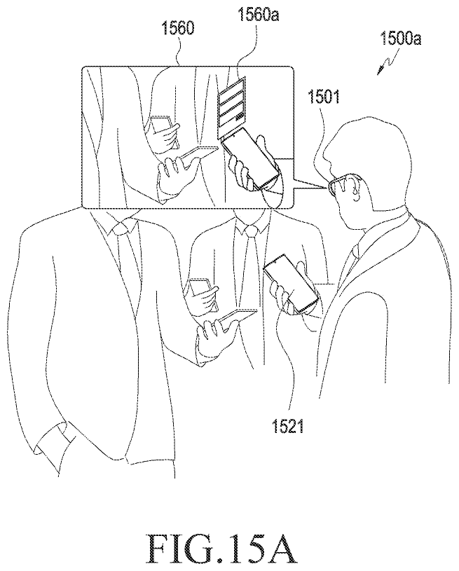

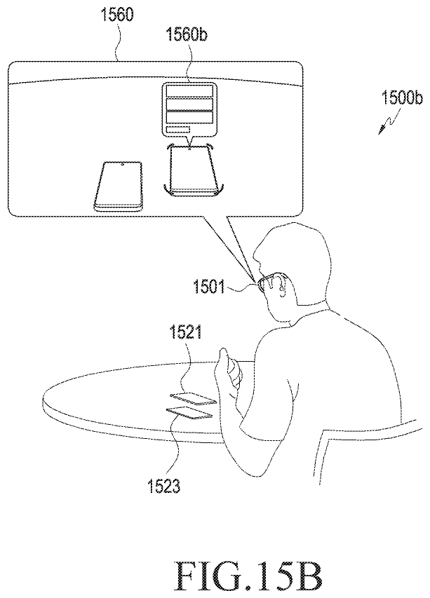

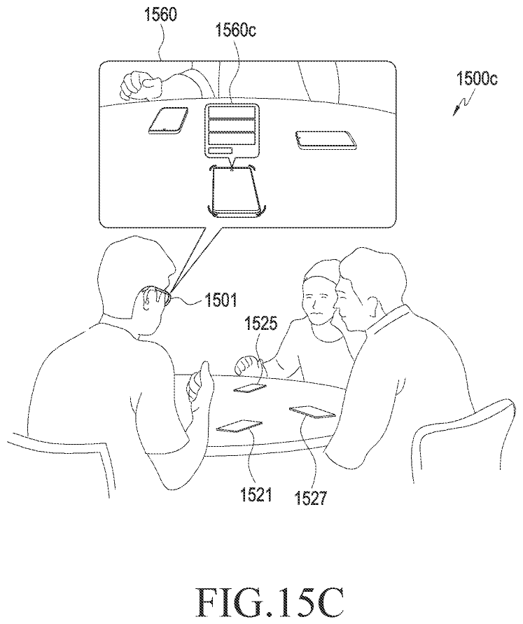

FIGS. 15A, 15B, and 15C are views 1500a, 1500b, and 1500c illustrating the operation of identifying a relevant device in an augmented reality mode of an electronic device according to various embodiments of the disclosure.

Referring to FIG. 15A, although there are a plurality of external electronic devices around the user when the user uses public transportation, the electronic device 1501 (e.g., AR glasses) worn on the user's eyes may display only information related to the first external electronic device having established communication with the electronic device 1501 as virtual object information. When a plurality of external electronic devices are present in the field of view of the camera of the electronic device while providing augmented reality via the display 1560, the electronic device 1501 may identify only the first device 1521 (e.g., a smartphone) as the first external electronic device having established communication with the electronic device 1501 via at least one identification operation of the first identification operation of FIGS. 7A and 7B, the second identification operation of FIG. 8, and/or the third identification operation of FIG. 9 and display only information 1560a related to the first device 1521 as virtual object information.

Referring to FIG. 15B, when there are two external electronic devices 1521 and 1523 of the same type (e.g., smartphone) in the field of view of the camera of the electronic device 1501 while providing augmented reality via the display 1560, the electronic device 1501 (e.g., AR glasses) worn on the user's eyes may identify only the first device 1521 as the first external electronic device having established communication with the electronic device 1501 via at least one identification operation of the first identification operation of FIGS. 7A and 7B, the second identification operation of FIG. 8, and/or the third identification operation of FIG. 9 and display only information 1560b related to the first device 1521 as virtual object information.

Referring to FIG. 15C, although there is a plurality of external electronic devices on a conference room table, the electronic device 1501 (e.g., AR glasses) worn on the user's eyes may display only information related to the first external electronic device having established communication with the electronic device 1501 as virtual object information. The electronic device 1501 may perform at least one identification operation of the first identification operation of FIGS. 7A and 7B, the second identification operation of FIG. 8, and/or the third identification operation of FIG. 9, on a plurality of external electronic devices 1521, 1525, and 1527 on the conference room table, present in the field of view of the camera of the electronic device while providing augmented reality via the display 1560, identify only the first device 1521 (e.g., a smartphone) as the first external electronic device having established communication with the electronic device 1501, and display only information 1560c related to the first device 1521 as virtual object information.

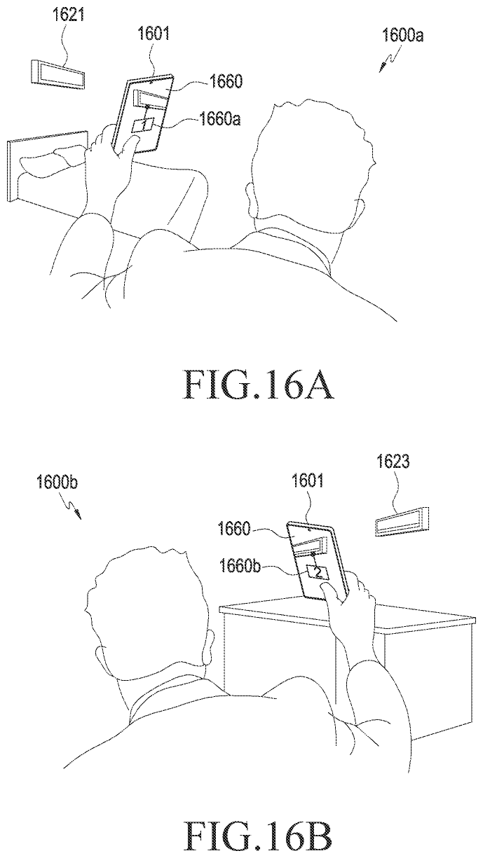

FIGS. 16A and 16B are views 1600a and 1600b illustrating the operation of identifying a relevant device in an augmented reality mode of an electronic device according to various embodiments of the disclosure.

Referring to FIG. 16A, when a first air conditioner 1621 is present in the field of view of the camera of the electronic device 1601 in a first room while providing augmented reality via the display 1660, an electronic device 1601 (e.g., a smartphone) may identify the first air conditioner 1621 as the first external electronic device having established communication with the electronic device 1601 via at least one identification operation of the first identification operation of FIGS. 7A and 7B, the second identification operation of FIG. 8, and/or the third identification operation of FIG. 9 and display information 1660a related to the first air conditioner 1621 as virtual object information.

Referring to FIG. 16B, when a second air conditioner 1623 is present in the field of view of the camera of the electronic device 1601 when the electronic device 1601 (e.g., a smartphone) moves to a second room while providing augmented reality via the display 1660, the electronic device 1601 (e.g., a smartphone) may identify the second air conditioner 1623 as the first external electronic device having established communication with the electronic device 1601 via at least one identification operation of the first identification operation of FIGS. 7A and 7B, the second identification operation of FIG. 8, and/or the third identification operation of FIG. 9 and display information 1660b related to the second air conditioner 1623 as virtual object information.

The electronic device according to various embodiments may be one of various types of electronic devices. The electronic devices may include, e.g., a portable communication device (e.g., a smartphone), a computer device, a portable multimedia device, a portable medical device, a camera, a wearable device, or a home appliance. According to an embodiment of the disclosure, the electronic device is not limited to the above-listed embodiments.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, a module may be implemented in the form of an application-specific integrated circuit (ASIC).

Various embodiments as set forth herein may be implemented as software (e.g., the program) including one or more instructions that are stored in a storage medium (e.g., internal memory or external memory) that is readable by a machine (e.g., the electronic device 201). For example, a processor (e.g., the processor 220) of the machine (e.g., the electronic device 201) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

As is apparent from the foregoing description, according to various embodiments, it is possible to identify an external electronic device related to an electronic device among at least one external electronic device while displaying the at least one external electronic device in augmented reality (AR) provided from the electronic device, thereby providing only information related to the identified external electronic device as virtual object information.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device, comprising:
a camera;
a display;
a transceiver; and
at least one processor configured to:
in case communication with a first external electronic device is established via the transceiver while providing augmented reality via the display, identify the first external electronic device among one or more external electronic devices present in a field of view of the camera based on information received from the first external electronic device and information obtained from the camera, and
display information related to the first external electronic device in the augmented reality (AR) provided via the display, as virtual object information.

2. The electronic device of claim 1, wherein the at least one processor is further configured to:
perform a first identification operation for identifying the first external electronic device among the one or more external electronic devices using device information;
in case a first device, among the one or more external electronic devices, obtains a score via the first identification operation, detect the first device as a candidate external electronic device;
in case the score obtained by the candidate external electronic device is smaller than an identification threshold, perform a second identification operation for identifying the first external electronic device using position information;
in case a total score obtained by the candidate external electronic device via the first identification operation and the second identification operation is smaller than the identification threshold, perform a third identification operation for identifying the first external electronic device using screen pattern information; and
in case a total score obtained by the candidate external electronic device via the first identification operation, the second identification operation, and the third identification operation is equal to or larger than the identification threshold, identify the candidate external electronic device as the first external electronic device.

3. The electronic device of claim 2, wherein the at least one processor is further configured to, in case the score obtained by the candidate external electronic device via the first identification operation is equal to or larger than the identification threshold, identify the candidate external electronic device as the first external electronic device.

4. The electronic device of claim 2, wherein the at least one processor is further configured to, in case the total score obtained by the candidate external electronic device via the first identification operation and the second identification operation is equal to or larger than the identification threshold, identify the candidate external electronic device as the first external electronic device.

5. The electronic device of claim 2, wherein the at least one processor is further configured to, in case the first external electronic device does not include a camera and the score obtained by the candidate external electronic device via the first identification operation is smaller than the identification threshold, skip the second identification operation and perform the third identification operation.

6. The electronic device of claim 2, wherein the at least one processor is further configured to, in the first identification operation, detect, as the candidate external electronic device, the first device having at least one of type information, product information, visual feature information, or sensor information of the first external electronic device, based on device information of the first external electronic device received from the first external electronic device and frame information obtained via the camera, and update the score for the candidate external electronic device.

7. The electronic device of claim 2, wherein the at least one processor is further configured to, in the second identification operation, detect first position information of a first device present in a field of view of the camera based on first frame information obtained via the camera, detect first position information of a second device present in a camera field of view of the first external electronic device, based on second frame information received from the first external electronic device and in case the first position information of the first device matches second position information of the first device, which is resultant from converting the first position information of the first device to correspond to a coordinate system of the second device, detect the first device as the candidate external electronic device, and update the score for the candidate external electronic device.

8. The electronic device of claim 7, wherein the at least one processor is further configured to, in case the first position information of the second device matches second position information of the second device, which is resultant from converting the first position information of the second device to correspond to a coordinate system of the first device, detect the first device as the candidate external electronic device and update the score for the candidate external electronic device.

9. The electronic device of claim 2, wherein the at least one processor is further configured to, in the third identification operation, detect the first device having screen pattern information matching screen pattern information of the first external electronic device among the one or more external electronic devices based on a frame obtained via the camera, detect the first device as the candidate external electronic device. and update the score for the candidate external electronic device.

10. The electronic device of claim 1, wherein the at least one processor is further configured to, in case the first external electronic device is identified among the one or more external electronic devices, continuously display information related to the first external electronic device as virtual object information by performing a tracking function for the first external electronic device.

11. A method for identifying a relevant device in an augmented reality mode of an electronic device, the method comprising:
establishing communication with a first external electronic device while providing augmented reality via a display of the electronic device;
identifying the first external electronic device among one or more external devices present in a field of view of a camera of the electronic device based on information obtained from the camera of the electronic device and information received from the first external electronic device; and
displaying information related to the first external electronic device in the augmented reality provided via the display.

12. The method of claim 11, further comprising:
performing a first identification operation for identifying the first external electronic device among the one or more external electronic devices using device information;
in case a first device, among the one or more external electronic devices, obtains a score via the first identification operation, detecting the first device as a candidate external electronic device;
in case the score obtained by the candidate external electronic device is smaller than an identification threshold, performing a second identification operation for identifying the first external electronic device using position information;
in case a total score obtained by the candidate external electronic device via the first identification operation and the second identification operation is smaller than the identification threshold, performing a third identification operation for identifying the first external electronic device using screen pattern information; and
in case a total score obtained by the candidate external electronic device via the first identification operation, the second identification operation, and the third identification operation is equal to or larger than the identification threshold, identifying the candidate external electronic device as the first external electronic device.

13. The method of claim 12, further comprising:
in case the score obtained by the candidate external electronic device via the first identification operation is equal to or larger than the identification threshold, identifying the candidate external electronic device as the first external electronic device.

14. The method of claim 12, further comprising:
in case the total score obtained by the candidate external electronic device via the first identification operation and the second identification operation is equal to or larger than the identification threshold, identifying the candidate external electronic device as the first external electronic device.

15. The method of claim 12, further comprising:
in case the first external electronic device does not include a camera and the score obtained by the candidate external electronic device via the first identification operation is smaller than the identification threshold, skipping the second identification operation and performing the third identification operation.

16. The method of claim 12, further comprising:
in the first identification operation, detecting, as the candidate external electronic device, the first device having at least one of type information, product information, visual feature information, or sensor information of the first external electronic device, based on device information of the first external electronic device received from the first external electronic device and frame information obtained via the camera, and updating the score for the candidate external electronic device.

17. The method of claim 12, further comprising:
in the second identification operation, detecting first position information of a first device present in a field of view of the camera based on first frame information obtained via the camera;
detecting first position information of a second device present in a camera field of view of the first external electronic device, based on second frame information received from the first external electronic device; and
in case the first position information of the first device matches second position information of the first device, which is resultant from converting the first position information of the first device to correspond to a coordinate system of the second device, detecting the first device as the candidate external electronic device and updating the score for the candidate external electronic device.

18. The method of claim 17, further comprising:
in case the first position information of the second device matches second position information of the second device, which is resultant from converting the first position information of the second device to correspond to a coordinate system of the first device, detecting the first device as the candidate external electronic device and updating the score for the candidate external electronic device.

19. The method of claim 12, further comprising:
in the third identification operation, detecting the first device having screen pattern information matching screen pattern information of the first external electronic device among the one or more external electronic devices based on a frame obtained via the camera; and
detecting the first device as the candidate external electronic device and updating the score for the candidate external electronic device.

20. The method of claim 11, further comprising:
in case the first external electronic device is identified among the one or more external electronic devices, continuously displaying information related to the first external electronic device as virtual object information by performing a tracking function for the first external electronic device.
